(19) United States
(12) Patent Application Publication
(10) Pub. No.: US 2014/0125219 A1
(43) Pub. Date: May 8, 2014

(54) ORGANIC LIGHT EMITTING DEVICE AND MANUFACTURING METHOD THEREOF

(71) Applicant: SAMSUNG DISPLAY CO., LTD., Yongin-city (KR)

(72) Inventors: Jin-Baek Choi, Yongin-City (KR); Ji-Young Choung, Yongin-City (KR); Joon-Gu Lee, Yongin-City (KR); Yeon-Hwa Lee, Yongin-City (KR); Won-Jong Kim, Yongin-City (KR); Hyun-Sung Bang, Yongin-City (KR)

(73) Assignee: SAMSUNG DISPLAY CO., LTD., Yongin-City (KR)

(21) Appl. No.: 13/797,870

(22) Filed: Mar. 12, 2013

(30) Foreign Application Priority Data
Nov. 5, 2012 (KR) 10-2012-0124126

(51) Int. Cl. H05B 33/04; H05B 33/28

(52) U.S. Cl. CPC H05B 33/04; H05B 33/28
USPC 313/503; 313/512; 445/58

(57) ABSTRACT

In an aspect, an organic light emitting device, including: a substrate; a first electrode on the substrate; an emission layer on the first electrode: a second electrode on the emission layer; and a conductive capping layer on the second electrode is provided.

### CROSS-REFERENCE TO RELATED APPLICATION

This application claims priority to and the benefit of Korean Patent Application No. 10-2012-0124126, filed on Nov. 5, 2012 in the Korean Intellectual Property Office, the disclosure of which is incorporated herein by reference in its entirety.

### BACKGROUND

1. Field

The present disclosure relates to an organic light emitting device and a manufacturing method of the organic light emitting device and more particularly, to an organic light emitting device in which a conductive capping layer is laminated on a cathode and a manufacturing method of the organic light emitting device.

2. Description of the Related Technology

An organic light emitting device (OLED) has utility as an image display medium because of a high response speed, low power consumption, and a wide viewing angle according to a self emission mode. Further, since the organic light emitting device may be manufactured through simple processes at a relatively low temperature, the organic light emitting device has received attention as a next-generation flat panel display device.

In general, an organic light emitting device may have a structure in which an anode and a cathode are sequentially placed on a flat insulating layer which covers a thin film transistor provided on a substrate, and an organic layer is interposed between the anode and the cathode.

During operation of an organic light emitting device holes supplied from the anode and electrons supplied from the cathode are coupled with each other in an organic layer formed between the anode and the cathode to form excitons having high energy where when the excitons fall down to lower energy, light is generated.

An organic light emitting device may be a rear emission or front emission type organic light emitting device according to a direction in which the light generated in the organic layer is emitted outside the device.

The rear emission type organic light emitting device is a mode in which light is emitted in the anode direction by using a transparent anode and a reflective cathode. In a rear emission type organic light emitting device there can be a problem in that a light emission area is reduced by an area occupied by a thin film transistor circuit disposed on the substrate.

As a method of solving the problem, a front emission type organic light emitting device which emits light in the cathode direction by using a reflective anode and a transflective cathode has been suggested.

A front emission type organic light emitting device may include a metal layer as a cathode. However, the metal layer which may be used as the cathode may need to be formed at a predetermined thickness in order to make the cathode into the transflective type, and as a result, there is a problem in that sheet resistance of the cathode is largely increased and thus power consumption is increased.

### SUMMARY

Some embodiments provide an organic light emitting device capable of reducing sheet resistance while maintaining an optical characteristic by laminating a conductive capping layer on a cathode and a manufacturing method thereof.

An exemplary embodiment of the present disclosure provides an organic light emitting device, including: a substrate; a first electrode on the substrate; an emission layer on the first electrode: a second electrode on the emission layer; and a conductive capping layer on the second electrode.

In some embodiments, the conductive capping layer may be formed with a single layer or multilayer.

In some embodiments, the second electrode may be formed as a transmissive electrode by using at least one of Mg:Ag, LiF:Al, Li:Al, Li, Ca, Ag, and Al.

In some embodiments, the conductive capping layer may contain indium oxide.

In some embodiments, the indium oxide may have a composition of represented by the formula InOₓ, and an x value may be 1.3 or more to less than 1.5.

In some embodiments, a thickness of the conductive capping layer may be 300 Å to 2,000 Å.

In some embodiments, a refractive index of the conductive capping layer may be 1.7 to 2.3.

Some embodiments provide a manufacturing method of an organic light emitting device, including: forming a first electrode on a substrate; forming an emission layer on the first electrode; forming a second electrode on the emission layer; and forming a conductive capping layer on the second electrode.

In some embodiments, the forming of the second electrode may include forming a transmissive electrode by using at least one of Mg:Ag, LiF:Al, Li:Al, Li, Ca, Ag, and Al as a material.

In some embodiments, the forming of the conductive capping layer may use indium oxide as a material, and an x value of the indium oxide may be 1.3 or more to less than 1.5.

In some embodiments, the forming of the conductive capping layer may include controlling a thickness of the conductive capping layer to be 300 Å to 2,000 Å.

In some embodiments, the forming of the conductive capping layer may use any one method of an ion beam deposition process, a spin coating process, a printing process, a sputtering process, a chemical vapor deposition (CVD) process, an atomic layer deposition (ALD) process, a plasma enhanced chemical vapor deposition (PECVD) process, a high density plasma-chemical vapor deposition (HDP-CVD) process, and a vacuum deposition process.

In some embodiments, the forming of the conductive capping layer may use an ion beam associated deposition process.

In some embodiments, ions injected during the ion beam associated deposition (IBAD) process may include argon (Ar) and oxygen (O₂).

In some embodiments, an injection velocity of argon (Ar) injected during the ion beam associated deposition (IBAD) process may be 5 to 30 cm²/min.

In some embodiments, an injection velocity of oxygen (O₂) injected during the ion beam associated deposition (IBAD) process may be 3 to 40 cm²/min.

According to some embodiments of the present disclosure, conductivity of a cathode becomes excellent by forming a conductive capping layer on the cathode made of transmissive metal to reduce sheet resistance, and as a result, power consumption of an organic light emitting device may be improved.

In some embodiments, the organic light emitting device may have a high transmission property by forming the conductive capping layer with indium oxide having a constant ratio of oxygen and indium to protect the organic light emitting device from external moisture and oxygen. Further, since the conductive capping layer made of indium oxide is amorphous, surface roughness is excellent and thus light extraction efficiency may be improved. In some embodiments, the indium oxide may have a composition of represented by the formula InOₓ, and an x value may be 1.3 or more to less than 1.5.

In some embodiments, light lost by total reflection is emitted outside by forming the conductive capping layer at a predetermined refractive index or more, and as a result, light extraction efficiency may be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view for describing an organic light emitting device according to an exemplary embodiment of the present disclosure.

FIGS. 2A to 2E are diagrams for describing a manufacturing method of the organic light emitting device according to the exemplary embodiment of the present disclosure.

FIG. 3A is a diagram illustrating a surface state of indium oxide according to the exemplary embodiment of the present disclosure, and FIG. 3B is a diagram illustrating a surface state of ITO for comparing the surface state of indium oxide. In some embodiments, the indium oxide may have a composition of represented by the formula InOₓ, and an x value may be 1.3 or more to less than 1.5.

### DETAILED DESCRIPTION

Hereinafter, the present disclosure will be described in more detail with reference to embodiments illustrated in the accompanying drawings. The scope of the present disclosure is not limited to drawings or embodiments described below. Exemplary embodiments to be described below and illustrated in the drawings may include various equivalences and modifications.

For reference, respective components and shapes thereof are schematically drawn or exaggeratedly drawn in the accompanying drawings for easy understanding. Like reference numerals designate like elements throughout the drawings.

Further, it will be understood that when a layer or an element is described as being “on” another layer or element, it may be directly disposed on another layer or element, or an intervening layer or element may also be present.

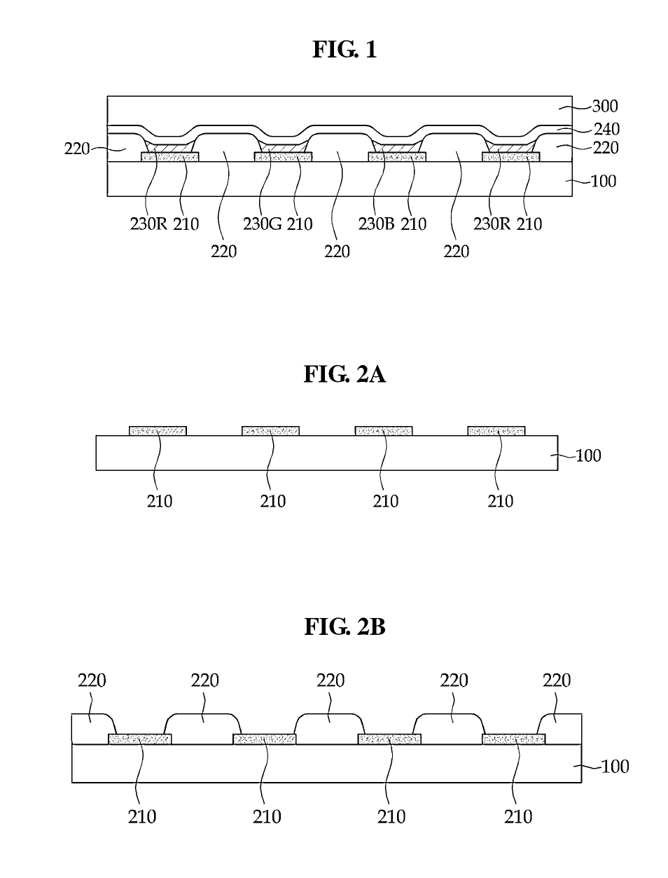

FIG. 1 is a cross-sectional view for describing an organic light emitting device according to an embodiment of the present disclosure.

Referring to FIG. 1, the organic light emitting device may include a substrate 100, a plurality of first electrodes 210 on the substrate, a pixel defining layer (PDL) 220 formed between the first electrodes 210 and overlapped with an end of the first electrode 210 to partition the first electrodes 210 by a pixel unit, an emission layer 230 (e.g. 230R, 230G, 230B) on the first electrode 210, a second electrode 240 on the emission layer 230, and a conductive capping layer 300 on the second electrode 240.

In some embodiments, the substrate 100 may be made of various materials such as a glass substrate, a quartz substrate, and a transparent resin substrate and may be formed by using a flexible material. In some embodiments, the transparent resin substrate which may be used as the substrate 100 may contain a polyimide resin, an acrylic resin, a polyacrylate resin, a polycarbonate resin, a polyether resin, a polyethylene terephthalate resin, a sulfonic acid resin, and the like.

In the case where the organic light emitting device is a rear emission type or a double emission type, the substrate 100 needs to be made of a transmissive material, but in the case of a front emission type, the substrate may not be necessarily made of the transmissive material. Hereinafter, for simplification of description, the organic light emitting device will be described based on the front emission type organic light emitting device.

In some embodiments, the first electrode 210 may be formed on the substrate 100. In some embodiments, the first electrode 210 may include a reflective film which is made of gold (Au), platinum (Pt), nickel (Ni), tungsten (W), chromium (Cr), molybdenum (Mo), iron (Fe), cobalt (Co), copper (Cu), palladium (Pd), titanium (Ti), and a compound thereof. In some embodiments, the first electrode 210 may include at least one transparent film made of ITO, IZO, AZO, ZnO, and the like having high work function in the reflective layer.

Although not illustrated in FIG. 1, a thin film transistor and an insulation layer protecting the thin film transistor may be further included between the substrate 100 and the first electrode 210. In this case, at least one thin film transistor may be formed for each pixel and electrically connected with the first electrode 210.

In some embodiments, the pixel defining layer (PDL) 220 which is overlapped with an end of the first electrode 210 to partition the first electrodes 210 by a pixel unit may be between the plurality of first electrodes 210. In some embodiments, the pixel defining layer (PDL) 220 is on the first electrode 210 to define an emission area and a non-emission area of the organic light emitting device.

In some embodiments, an emission layer 230 may be formed on the emission area of the first electrode 210 partitioned by the pixel defining layer 220. In some embodiments, the emission layer 230 may be formed by a red emission layer 230R, a green emission layer 230G, and a blue emission layer 230B containing a red emission material, a green emission material, and a blue emission material according to each pixel of the organic light emitting device.

Although not illustrated in FIG. 1, a hole injection layer (HIL) for smoothly injecting holes to the emission layer 230 and a hole transfer layer (HTL) may be included below the emission layer 230, and an electron transport layer (ETL) for smoothly injecting electrons to the emission layer 230 and an electron injection layer (EIL) may be included above the emission layer 230.

In some embodiments, the second electrode 240 may be formed on the pixel defining layer 220 and the emission layer 230. In the case of the front emission type organic light emitting device, the second electrode 240 may contain a transmissive metal. In some embodiments, the transmissive metal may use Mg:Ag, LiF:Al, Li:Al, Li, Ca, Ag, Al, and the like having low work function.

In some embodiments, the second electrode 240 may be formed at a regular thickness within the range of 100 Å to 400 Å. In the case where the second electrode 240 is formed at a thickness of less than 100 Å, there is a problem in that transmittance is increased, but conductivity is decreased, and in the case where the second electrode 240 is more than 400 Å, there is a problem in that the transmittance is decreased.

As such, in the front emission type organic light emitting device, since the second electrode 240 is formed at a predetermined thickness or less, for example, range of about 100 Å to 400 Å, a sheet resistance value of the second electrode 240 is increased and thus power consumption of the organic light emitting device is increased.

In some embodiments, the conductive capping layer 300 having conductivity may be formed above the second electrode 240 to reduce sheet resistance that may occur due to thickness of the second electrode 240.

In some embodiments, the conductive capping layer 300 may be made of oxide having high transmittance and conductivity. The oxide having high transmittance and conductivity may be indium oxide. In some embodiments, the indium oxide may have a composition of represented by the formula InOₓ, and an x value may be 1.3 or more to less than 1.5.

In some embodiments, the conductive capping layer 300 containing the indium oxide may be formed at the thickness of 300 Å to 2,000 Å. In some embodiments having a thickness of the conductive capping layer 300 less than 300 Å is not preferable because the conductivity is not good. In some embodiments having a thickness more than 2,000 Å is not preferable since there may be a problem with the transmittance. Thus, it is preferable that the thickness is 2,000 Å or less, but if there is no problem with the transmittance, the thickness may be more than 2,000 Å. In some embodiments, the indium oxide may have a composition of represented by the formula InOₓ, and an x value may be 1.3 or more to less than 1.5.

Hereinafter, Examples of the present disclosure will be described. However, the following Examples are just exemplified in order to better understand the present disclosure and the present disclosure is not limited to the following Examples.

### EXAMPLE 1

Al (100 Å) and Mg:Ag (150 Å) (which are materials of the second electrode 240) are deposited on a glass substrate and then indium oxide represented by formula InOx, average x value is about 1.36, is deposited on the Al (100 Å) and Mg:Ag (150 Å) with a thickness of 600 Å providing a sheet resistance of 28 Ω/m2.

### EXAMPLE 2

Al (100 Å) and Mg:Ag (150 Å) (which are materials of the second electrode 240) are deposited on a glass substrate and then indium oxide represented by formula InOx, average x value is about 1.36, is deposited on the Al (100 Å) and Mg:Ag (150 Å) with a thickness of 1,800 Å providing a sheet resistance of 15 Ω/m2.

### COMPARATIVE EXAMPLE

Al (100 Å) and Mg:Ag (150 Å) (which are materials of the second electrode 240) are deposited on a glass substrate providing a sheet resistance of 30 Ω/m2.

When comparing the sheet resistance values of Examples 1 and 2 and Comparative Example, it shown that in the case where the second electrode is formed by using Al and Mg:Ag, the sheet resistance value is high at 30 Ω/m2, while in the case where indium oxide represented by formula InOx is laminated on the second electrode with the thickness of 600 Å, the sheet resistance value is decreased to 28 Ω/m2. Further, in the case where indium oxide represented by formula InOx is laminated on the second electrode with the thickness of 1,800 Å, the sheet resistance value is significantly decreased to 15 Ω/m2 at ½ level where the second electrode is formed by using Al and Mg:Ag.

Further, since transmittance of the conductive capping layer 300 made of the indium oxide represented by formula InOx is 80% or more throughout a visible light area, the transmittance does not largely influence an optical property of the organic light emitting device due to the conductive capping layer.

As such, in the organic light emitting device including the conductive capping layer 300 according to the exemplary embodiment of the present disclosure, the sheet resistance of the second electrode 240 may be reduced while maintaining light emission efficiency. Accordingly, power consumption of the organic light emitting device may be reduced and a large-area organic light emitting device of 14 inches or more may be implemented.

Further, when the thickness of the conductive capping layer 300 made of the indium oxide represented by formula InOx according to the exemplary embodiment of the present disclosure is 1,000 Å, a refractive index of the conductive capping layer 300 may have a value of 1.7 to 2.3. When the refractive index of the conductive capping layer 300 has a high value of 1.7 or more, the light that is lost due to total reflection in the second electrode 240 may be extracted outside and thus light extraction efficiency of the organic light emitting device may be improved. In some embodiments, the indium oxide may have a composition of represented by the formula InOₓ, and an x value may be 1.3 or more to less than 1.5.

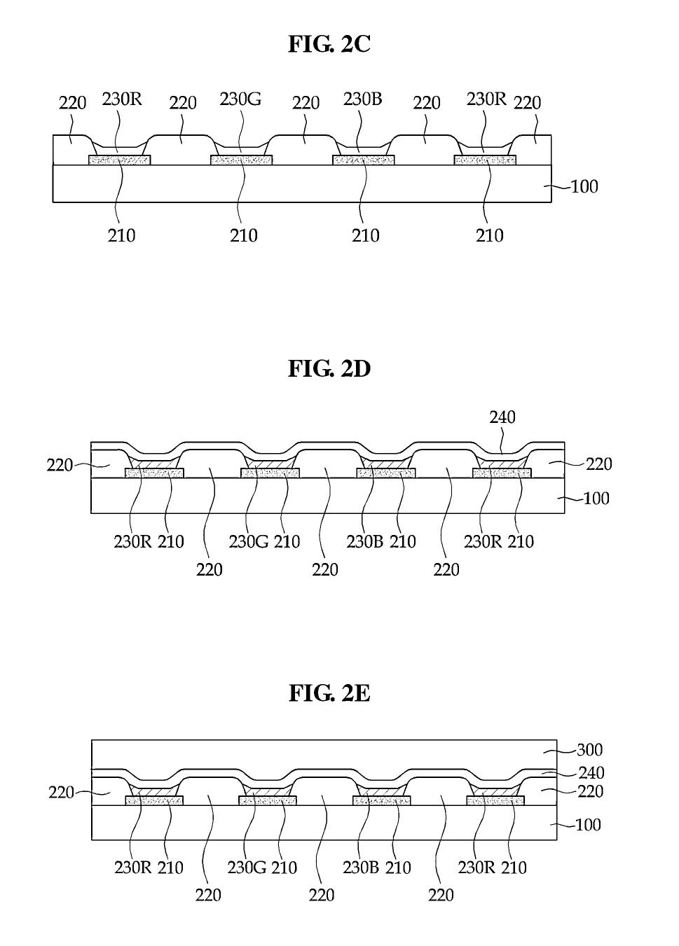

FIGS. 2A to 2E are diagrams for describing a manufacturing method of the organic light emitting device according to the exemplary embodiment of the present disclosure.

In some embodiments, the manufacturing method may include (a) forming a plurality of first electrodes 210 on the substrate 100, (b) forming a pixel defining layer 220 between the plurality of first electrodes 210, (c) forming an emission layer 230 on the first electrode 210, (d) forming a second electrode 240 on the emission layer 230, and (e) forming a conductive capping layer 300 on the second electrode 240.

Referring to FIG. 2A, the plurality of first electrodes 210 may be formed on the substrate 100. In some embodiments, the first electrode 210 may be formed by coating and patterning a material for forming the first electrode on the substrate 100. In some embodiments, the material for forming the first electrode may be coated by using any one method of a spin coating process, a printing process, a sputtering process, a chemical vapor deposition (CVD) process, an atomic layer deposition (ALD) process, a plasma enhanced chemical vapor deposition (PECVD) process, a high density plasma-chemical vapor deposition (HDP-CVD) process, and a vacuum deposition process.

Referring to FIG. 2B, the pixel defining layer 220 may be formed on the substrate 100 with the first electrodes 210. In some embodiments, the pixel defining layer 220 may be formed by using an organic material, an inorganic material, and the like. In some embodiments, a material for forming the pixel defining layer may be coated on the substrate 100 with the first electrodes 210 and then etched to form an opening exposing a part of the first electrode 210. In some embodiments, the opening may be formed by using a photolithography process or an additional etching mask.

Referring to FIG. 2C, the emission layer 230 (e.g. 230R, 230G, 230B) may be formed on the opening of the first electrode 210 partitioned by the pixel defining layer 220. In some embodiments, the emission layer 230 may include a red emission layer 230R, a green emission layer 230G, and a blue emission layer 230B for each pixel. In some embodiments, the emission layer 230 may be formed by using light emission materials capable of generating different color light such as red light, green light, and blue light according to each pixel.

Referring to FIG. 2D, the second electrode 240 may be formed on the pixel defining layer 220 and the emission layer 230. In some embodiments, the second electrode 240 may be formed only on the emission layer 230 (e.g. 230R, 230G, 230B). In some embodiments, the second electrode 240 may be formed within the range of 150 Å to 400 Å at a regular thickness by using transmissive metal such as Mg:Ag, LiF:Al, Li:Al, Li, Ca, Ag, and Al. In some embodiments, a material for forming the second electrode 240 may be formed by using any one method of a spin coating process, a printing process, a sputtering process, a chemical vapor deposition (CVD) process, an atomic layer deposition (ALD) process, a plasma enhanced chemical vapor deposition (PECVD) process, a high density plasma-chemical vapor deposition (HDP-CVD) process, and a vacuum deposition process.

Referring to FIG. 2E, the conductive capping layer 300 may be formed on the second electrode 240. In some embodiments, the conductive capping layer 300 may be formed with the thickness of 300 Å to 2,000 Å by using indium oxide represented by formula InOx. In some embodiments, the indium oxide may have a composition of represented by the formula InOₓ, and an x value may be 1.3 or more to less than 1.5.

In some embodiments, the conductive capping layer 300 may be formed by using any one method of an ion beam deposition process, a spin coating process, a printing process, a sputtering process, a chemical vapor deposition (CVD) process, an atomic layer deposition (ALD) process, a plasma enhanced chemical vapor deposition (PECVD) process, a high density plasma-chemical vapor deposition (HDP-CVD) process, and a vacuum deposition process.

In some embodiments, the conductive capping layer 300 may be formed by using an ion beam associated deposition (hereinafter, referred to as IBAD) process. The IBAD process is a method of forming a thin film having a desired composition by depositing a source and simultaneously irradiating ions having energy on the substrate surface.

According to the exemplary embodiment of the present disclosure, the conductive capping layer 300 having a desired composition may be formed by depositing a source of indium oxide represented by formula InOx on the substrate 100 with the second electrode 240 and simultaneously irradiating argon (Ar) and oxygen (O₂) on the substrate 100. In some embodiments, the indium oxide may have a composition of represented by the formula InOₓ, and an x value may be 1.3 or more to less than 1.5.

A composition ratio of formed indium oxide represented by formula InOx depends on a kind of source used in the IBAD process and a velocity of the irradiated ions.

In some embodiments, the source of the indium oxide represented by formula InOx may use indium (In) metal, In₂O₃ pellet, or a wire.

In some embodiments, the argon (Ar) which is irradiated simultaneously with the deposited indium oxide represented by formula InOx source is injected at a velocity of 5 to 30 cm²/min, and the oxygen (O₂) may be injected at a velocity of 3 to 40 cm²/min.

In some embodiments, an x value of indium oxide (InOx) forming the conductive capping layer 300 may be formed to be 1.3 or more to less than 1.5 through the process.

In the case where the x value of indium oxide represented by formula InOx forming the conductive capping layer 300 is 1.3 or more to less than 1.5, the conductive capping layer 300 may efficiently protect the organic light emitting device from external moisture or oxygen.

In some embodiments, when the x value is less than 1.5, the indium oxide represented by formula InOx is changed to an amorphous form to reduce input of oxygen or external gas. In some embodiments, when the x value is less than 1.3, since a structure of the indium oxide represented by formula InOx is not formed, it is difficult to form the thin film.

In the case of an organic light emitting device using a known PET film as a protective layer, a water vapor transmission rate (WVTR) is 5.5 to 7.0 g/m2_day, while in the case where the x value of the indium oxide represented by formula InOx is 1.3 or more to less than 1.5, the water vapor transmission rate (WVTR) has a vapor transmission property at a high level of 0.15 g/m2_day or less.

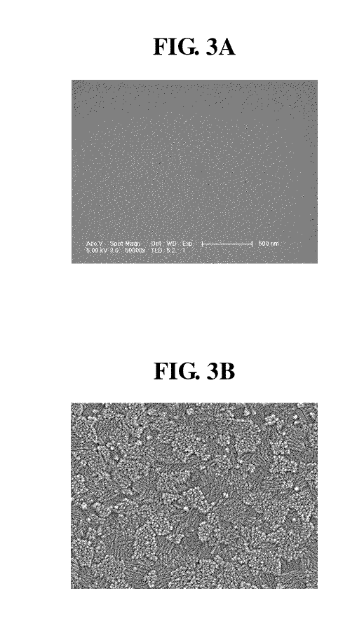

FIGS. 3A and 3B are diagrams illustrating a surface state of indium oxide (InOx) and a surface state of indium tin oxide (ITO) according to the exemplary embodiment of the present disclosure.

FIG. 3A illustrates a surface state of indium oxide represented by formula InOx according to the exemplary embodiment of the present disclosure. In the case where the x value of the indium oxide represented by formula InOx is 1.3 or more to less than 1.5, since the indium oxide (InOx) is amorphous, as illustrated in FIG. 3A, surface roughness is excellent.

FIG. 3B illustrates a surface state of indium tin oxide (ITO), and since the indium tin oxide (ITO) is crystalline, the surface roughness is rougher than the indium tin oxide (ITO).

Accordingly, the case where the conductive capping layer 300 is made of the indium oxide represented by formula InOx may be advantageous with respect to light extraction efficiency than the case where the conductive capping layer 300 is made of indium tin oxide (ITO).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An organic light emitting device, comprising:
a substrate;
a first electrode on the substrate;
an emission layer on the first electrode;
a second electrode on the emission layer; and
a conductive capping layer on the second electrode.

2. The organic light emitting device of claim 1, wherein the conductive capping layer is formed with a single layer or multilayer.

3. The organic light emitting device of claim 1, wherein the second electrode includes at least one of Mg:Ag, LiF:Al, Li:Al, Li, Ca, Ag, and Al.

4. The organic light emitting device of claim 1, wherein the conductive capping layer contains indium oxide.

5. The organic light emitting device of claim 4, wherein the indium oxide has a composition of InOₓ, and an x value is 1.3 or more to less than 1.5.

6. The organic light emitting device of claim 1, wherein a thickness of the conductive capping layer is 300 Å to 2,000 Å.

7. The organic light emitting device of claim 1, wherein a refractive index of the conductive capping layer is 1.7 to 2.3.

8. A manufacturing method of an organic light emitting device, comprising:
forming a first electrode on a substrate;
forming an emission layer on the first electrode;
forming a second electrode on the emission layer; and
forming a conductive capping layer on the second electrode.

9. The manufacturing method of an organic light emitting device of claim 8, wherein at least one of Mg:Ag, LiF:Al, Li:Al, Li, Ca, Ag, and Al is a material for forming of the second electrode.

10. The manufacturing method of an organic light emitting device of claim 8, wherein indium oxide is a material for forming of the conductive capping layer.

11. The manufacturing method of an organic light emitting device of claim 10, wherein the indium oxide has a composition of InOₓ, and an x value is 1.3 or more to less than 1.5.

12. The manufacturing method of an organic light emitting device of claim 8, wherein the forming of the conductive capping layer includes controlling a thickness of the conductive capping layer to be 300 Å to 2,000 Å.

13. The manufacturing method of an organic light emitting device of claim 8, wherein the forming of the conductive capping layer uses any one method of an ion beam deposition process, a spin coating process, a printing process, a sputtering process, a chemical vapor deposition (CVD) process, an atomic layer deposition (ALD) process, a plasma enhanced chemical vapor deposition (PECVD) process, a high density plasma-chemical vapor deposition (HDP-CVD) process, and a vacuum deposition process.

14. The manufacturing method of an organic light emitting device of claim 8, wherein the forming of the conductive capping layer uses an ion beam associated deposition process.

15. The manufacturing method of an organic light emitting device of claim 14, wherein ions injected during the ion beam associated deposition (IBAD) process are argon (Ar) and oxygen (O₂).

16. The manufacturing method of an organic light emitting device of claim 15, wherein the injection velocity of argon (Ar) injected during the ion beam associated deposition (IBAD) process is 5 to 30 cm²/min.

17. The manufacturing method of an organic light emitting device of claim 15, wherein the injection velocity of oxygen (O₂) injected during the ion beam associated deposition (IBAD) process is 3 to 40 cm2/min.
